(19) United States
(12) Patent Application Publication
(10) Pub. No.: US 2026/0029920 A1
(43) Pub. Date: Jan. 29, 2026

(54) INTERNALLY MODIFYING ACCESS COMMAND LATENCY

(71) Applicant: Micron Technology, Inc., Boise, ID (US)

(72) Inventors: Kevin GAJERA, Munich (DE); Filippo VITALE, Haimhausen (DE)

(21) Appl. No.: 19/220,620

(22) Filed: May 28, 2025

Related U.S. Application Data
(60) Provisional application No. 63/675,766, filed on Jul. 26, 2024.

(51) Int. Cl. G06F 3/06

(52) U.S. Cl. CPC G06F 3/0611; G06F 3/0659; G06F 3/0673

(57) ABSTRACT

In some implementations, a memory device may identify a count value associated with an oscillator circuit of the memory device. The memory device may determine, using the count value, whether a delay associated with a data path of the memory device satisfies a threshold. The memory device may selectively, based on determining whether the delay satisfies the threshold, modify a latency associated with a decoder of the memory device by a first value or modify the latency by a second value.

### CROSS-REFERENCE TO RELATED APPLICATION

This patent application claims priority to U.S. Provisional Patent Application No. 63/675,766, filed on Jul. 26, 2024, entitled “INTERNALLY MODIFYING ACCESS COMMAND LATENCY,” and assigned to the assignee hereof. The disclosure of the prior application is considered part of and is incorporated by reference into this patent application.

### TECHNICAL FIELD

The present disclosure generally relates to memory devices, memory device operations, and, for example, to internally modifying access command latency.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of internally modifying access command latency.

FIG. 2 is a circuit diagram of an example memory cell.

FIG. 3 is a diagram illustrating an example of a system that supports internally modifying access command latency.

FIGS. 4A and 4B are diagrams of an example that supports internally modifying access command latency.

FIG. 5 is a flowchart of an example method associated with internally modifying access command latency.

FIG. 6 is a flowchart of an example method associated with internally modifying access command latency.

FIG. 7 is a flowchart of an example method associated with internally modifying access command latency.

### DETAILED DESCRIPTION

Some computing systems, such as a computing system that includes a host system, such as one or more central processing units (CPUs), one or more graphics processing units (GPUs), and/or one or more accelerators, in communication with a synchronous memory system, such as a graphics double data rate (GDDR) synchronous dynamic random access memory (SDRAM) system, may communicate data at a relatively high transfer speed (e.g., a rate at which data is communicated between a memory apparatus and a host system). To facilitate increased data transfer speeds, such systems may employ synchronous clock signals. As described herein, “synchronous clock signals” refers to the coordination of clock signals used by the host system and the memory system. For example, the host system may maintain one or more clock signals (e.g., processor clock signals). The host system may provide, and the memory system may obtain, a clock signal that is synchronized with a processor clock signal (e.g., the clock signal of the memory system may be in-phase with the processor signal and/or may have the same frequency as the processor clock signal).

Such computing systems may manage access operations in accordance with the synchronized clock signals. For example, a read operation may be associated with a read latency. As described herein, “read latency” refers to the duration (e.g., a quantity of clock signals and/or an amount of time) between the host system providing a read command and the memory system completing an associated read operation. To perform a read operation, a decoder of the memory system (e.g., a command/address (C/A) decoder) may, after a duration from obtaining a read command, issue a read start signal to one or more components of a data path. As described herein, the duration between obtaining the read command and issuing the read start signal may be referred to as the C/A latency. In response to obtaining the read start signal, the component(s) of the data path may retrieve data associated with the read command from one or more memory arrays. In some examples, the component(s) of the data path may perform one or more operations on the data (e.g., error control operations, decoding operations, and/or encoding operations, among other examples). The component(s) of the data path may store the data to one or more read buffers. After the read latency has elapsed, the host system may retrieve the data from the read buffer(s). Thus, the sum of the C/A latency and the duration between the decoder issuing the read start signal and the data path storing the data to the one or more read buffers, which may be referred to as the data path delay, may be less than the read latency. However, if the sum of the C/A latency and the data delay is greater than the read latency, then the host system may be unable to retrieve the data from the read buffer(s), a condition which may be referred to as underflow.

In some examples, the host system may provide, and the memory system may obtain, consecutive read commands. In such examples, the duration between consecutive read commands, which may be referred to as the read interval, may be less than the read latency. Accordingly, the memory system may store data associated with multiple read commands to the one or more read buffers concurrently. If the amount of space in the one or more read buffers (e.g., the quantity of read buffers) is less than the size of read data to be stored, a condition which may be referred to as overflow, the memory system may be unable to process additional read commands and may thus increase latency associated with processing read commands. Accordingly, the size of the one or more read buffers may, based on the read interval, the C/A latency, and the data path delay, be selected to mitigate overflow and to mitigate underflow.

However, in some examples, the data path delay may change as the operating conditions of the memory system change. For example, as the temperature and/or the operating voltage of the memory system change (e.g., due to noise or other fluctuations in the supply voltage), the rate at which transistors or other components of the data path activate and/or deactivate (e.g., the switching speed) may change. Further, process variations (e.g., variations in transistor properties, such as channel length, doping concentration, and/or impurities, among other examples) may result in variations in switching times. Such variations in the data path delay may result the one or more read buffers being too small, thus leading to overflow, or may result in reducing read latency (e.g., to avoid overflow), which may lead to overflow underflow for a larger data path delay.

Some implementations as described herein may enable internally modifying the access command latency of a memory system. For example, the memory system may include an oscillator circuit configured to provide information associated with the operating conditions and/or process conditions of the memory system. As described in greater detail elsewhere herein, changes in the period of the oscillator circuit due to operating condition variations and/or process condition variations may be commensurate with changes to the delay of the data path due to the operating condition variations. Said another way, an increase in the period (e.g., a lower frequency) of the oscillator circuit may correspond to an increase in the delay of the data path. Similarly, a decrease in the period (e.g., a higher frequency) of the oscillator circuit may correspond to a decrease in the delay of the data path.

The memory system may extract information associated with the operating condition variations from the oscillator circuit. For example, the decoder of the memory system may issue, and the oscillator circuit may obtain, a count start signal. Based on, in response to, or otherwise associated with obtaining the count start signal, the oscillator circuit may provide a count value indicating a measured metric (e.g., a measured period and/or a measured frequency) of the oscillator circuit to the decoder. The decoder may select a value by which to modify the C/A latency using the measured metric. For example, the decoder may compare the measured metric to a reference metric, such as a reference period and/or a reference frequency, of the oscillator circuit. If the measured period is greater than the reference period, and/or if the measured frequency is less than the reference frequency, then the decoder may reduce the C/A latency by a first value. Alternatively, if the measured period is less than the reference period, and/or if the measured frequency is greater than the reference frequency, then the decoder may increase the C/A latency by a second value.

Additionally, or alternatively, the decoder may modify the C/A latency by an amount commensurate with the measured metric. For example, the decoder may use a mapping, such as a look-up table. The mapping may include one or more entries that indicate associations between possible metrics and associated C/A latencies. For example, an entry may include a metric, and/or a range of metrics, and an associated C/A latency. The decoder may use the mapping to identify a C/A latency associated with the measured metric, such as by identifying an entry having a metric nearest the measured metric and/or by identifying an entry having a range of metrics that includes the measured metric. The decoder may modify the C/A latency to be the C/A identified latency.

As a result, by enabling internal modifications of the access command latency, the memory system may reduce underflow and/or overflow conditions in the one or more read buffers. For example, by modifying the C/A latency based on the measured metric of the oscillator circuit, the memory system may reduce variations in duration between the memory system obtaining a read command and the memory system storing data associated with the read command to one or more read buffers. Accordingly, the memory system may mitigate underflow of the one or more read buffers, which may improve system performance, such as by reducing latency of the memory system. Additionally, the memory system may mitigate overflow of the one or more read buffers, which may allow for a more efficient size of the memory system, decreased manufacturing costs, and/or decrease system complexity, among other benefits.

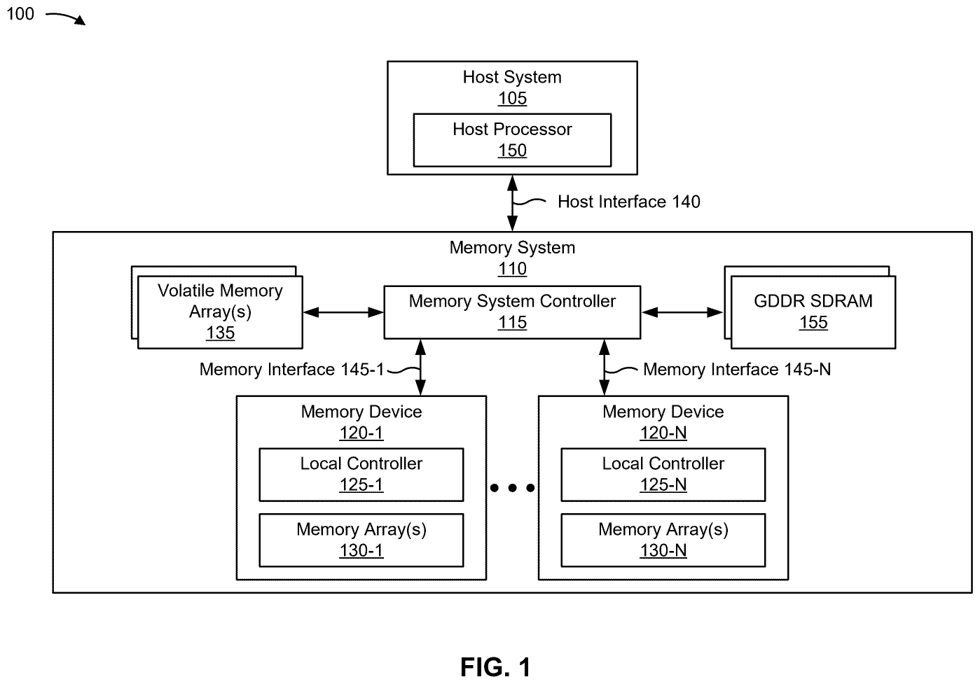

FIG. 1 is a diagram illustrating an example system 100 capable of internally modifying access command latency. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array, a GDDR SDRAM array, or a DRAM array). In some implementations, the memory system 110 may include one or more volatile memory arrays 135. A volatile memory array 135 may include an SRAM array, a GDDR SDRAM array, and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

The memory system may include a GDDR SDRAM 155. In some examples, GDDR SDRAM 155 may include one or more memory arrays used to store data associated with video memory (e.g., memory used for graphics rendering). In some cases, the GDDR SDRAM 155 may be associated with a synchronized clock signal, such as a read clock signal synchronized with an external clock signal (e.g., a clock signal provided by the host system 105). For example, the memory system 110 may include circuitry configured to generate a read clock signal that is synchronized with the external clock signal. Additionally, or alternatively, the memory system 110 may include circuitry configured to generate a read clock signal that may be divided from the external clock signal. For example, the memory system 110 may generate a read clock signal having a frequency that is a fraction of the frequency of the external clock signal (e.g., one fourth of the frequency of the external clock signal, one half of the frequency of the external clock signal). As part of a memory access command to retrieve data stored in the GDDR SDRAM 155, the memory system 110 may provide the read clock signal and the data to the host system 105. The host system 105 may interpret the data (e.g., latch data included in a data signal) using the read clock signal. In some examples, the GDDR SDRAM 155 may be included in one or memory arrays of the memory system 110, such as the volatile memory array(s) 135 and/or the memory array(s) 130. Additionally, or alternatively, the GDDR SDRAM 155 may be a separate from the volatile memory array(s) 135 and/or the memory array(s) 130.

In some implementations, one or more systems, devices, apparatuses, components, and/or controllers of FIG. 1 may include: an oscillator circuit configured to provide a count value; a data path; and a decoder configured to: determine, using the count value, whether a delay associated with the data path satisfies a threshold; and selectively, based on the determination of whether the delay satisfies the threshold, modify a latency associated with the decoder by a first value or modify the latency by a second value.

In some implementations, one or more systems, devices, apparatuses, components, and/or controllers of FIG. 1 may include: a GDDR SDRAM; an oscillator circuit configured to provide a count value; a data path of the GDDR SDRAM; and a decoder configured to: select, based on the count value and a delay associated with the data path, a value; and modify a latency associated with a memory access command for the GDDR SDRAM.

In some implementations, one or more systems, devices, apparatuses, components, and/or controllers of FIG. 1 may be configured to identify a count value associated with an oscillator circuit of the memory device; determine, using the count value, whether a delay associated with a data path of the memory device satisfies a threshold; and selectively, based on determining whether the delay satisfies the threshold, modify a latency associated with a decoder of the memory device by a first value or modify the latency by a second value.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

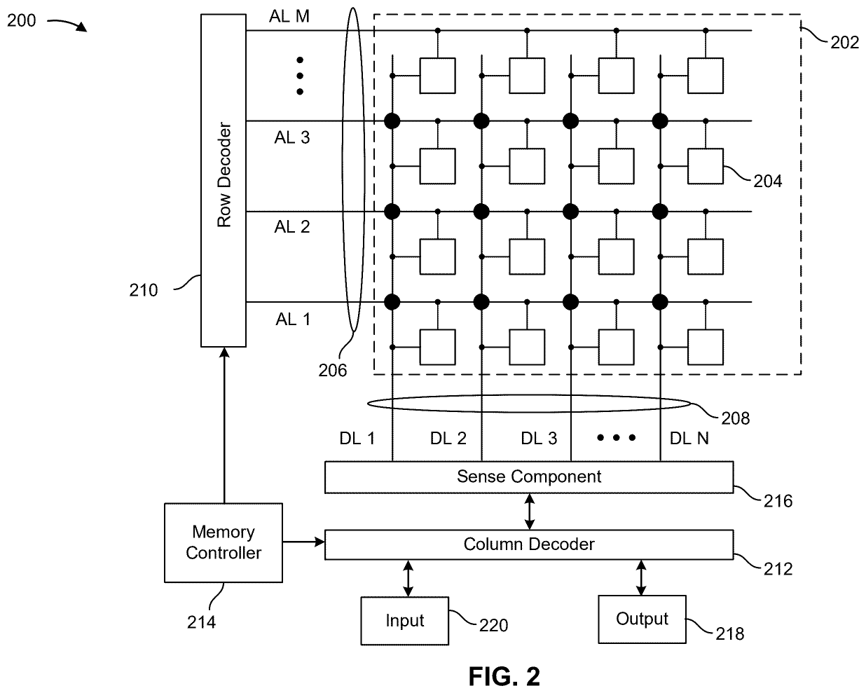

FIG. 2 is a diagrammatic view of an example memory device 200. The memory device 200 may include a memory array 202 that includes multiple memory cells 204. A memory cell 204 is programmable or configurable into a data state of multiple data states (e.g., two or more data states). For example, a memory cell 204 may be set to a particular data state at a particular time, and the memory cell 204 may be set to another data state at another time. A data state may correspond to a value stored by the memory cell 204. The value may be a binary value, such as a binary 0 or a binary 1, or may be a fractional value, such as 0.5, 1.5, or the like. A memory cell 204 may include a capacitor to store a charge representative of the data state. For example, a charged and an uncharged capacitor may represent a first data state and a second data state, respectively. As another example, a first level of charge (e.g., fully charged) may represent a first data state, a second level of charge (e.g., fully discharged) may represent a second data state, a third level of charge (e.g., partially charged) may represent a third data state, and so on.

Operations such as reading and writing (i.e., cycling) may be performed on memory cells 204 by activating or selecting the appropriate access line 206 (shown as access lines AL 1 through AL M) and digit line 208 (shown as digit lines DL 1 through DL N). An access line 206 may also be referred to as a “row line” or a “word line,” and a digit line 208 may also be referred to a “column line” or a “bit line.” Activating or selecting an access line 206 or a digit line 208 may include applying a voltage to the respective line. An access line 206 and/or a digit line 208 may comprise, consist of, or consist essentially of a conductive material, such as a metal (e.g., copper, aluminum, gold, titanium, or tungsten) and/or a metal alloy, among other examples. In FIG. 2, each row of memory cells 204 is connected to a single access line 206, and each column of memory cells 204 is connected to a single digit line 208. By activating one access line 206 and one digit line 208 (e.g., applying a voltage to the access line 206 and digit line 208), a single memory cell 204 may be accessed at (e.g., is accessible via) the intersection of the access line 206 and the digit line 208. The intersection of the access line 206 and the digit line 208 may be called an “address” of a memory cell 204.

In some implementations, the logic storing device of a memory cell 204, such as a capacitor, may be electrically isolated from a corresponding digit line 208 by a selection component, such as a transistor. The access line 206 may be connected to and may control the selection component. For example, the selection component may be a transistor, and the access line 206 may be connected to the gate of the transistor. Activating the access line 206 results in an electrical connection or closed circuit between the capacitor of a memory cell 204 and a corresponding digit line 208. The digit line 208 may then be accessed (e.g., is accessible) to either read from or write to the memory cell 204.

A row decoder 210 and a column decoder 212 may control access to memory cells 204. For example, the row decoder 210 may receive a row address from a memory controller 214 and may activate the appropriate access line 206 based on the received row address. Similarly, the column decoder 212 may receive a column address from the memory controller 214 and may activate the appropriate digit line 208 based on the column address.

Upon accessing a memory cell 204, the memory cell 204 may be read (e.g., sensed) by a sense component 216 to determine the stored data state of the memory cell 204. For example, after accessing the memory cell 204, the capacitor of the memory cell 204 may discharge onto its corresponding digit line 208. Discharging the capacitor may be based on biasing, or applying a voltage, to the capacitor. The discharging may induce a change in the voltage of the digit line 208, which the sense component 216 may compare to a reference voltage (not shown) to determine the stored data state of the memory cell 204. For example, if the digit line 208 has a higher voltage than the reference voltage, then the sense component 216 may determine that the stored data state of the memory cell 204 corresponds to a first value, such as a binary 1. Conversely, if the digit line 208 has a lower voltage than the reference voltage, then the sense component 216 may determine that the stored data state of the memory cell 204 corresponds to a second value, such as a binary 0. The detected data state of the memory cell 204 may then be output (e.g., via the column decoder 212) to an output component 218 (e.g., a data buffer). A memory cell 204 may be written (e.g., set) by activating the appropriate access line 206 and digit line 208. The column decoder 212 may receive data, such as input from input component 220, to be written to one or more memory cells 204. A memory cell 204 may be written by applying a voltage across the capacitor of the memory cell 204.

The memory controller 214 may control the operation (e.g., read, write, re-write, refresh, and/or recovery) of the memory cells 204 via the row decoder 210, the column decoder 212, and/or the sense component 216. The memory controller 214 may generate row address signals and column address signals to activate the desired access line 206 and digit line 208. The memory controller 214 may also generate and control various voltages used during the operation of the memory array 202.

In some implementations, the memory device 200 may include, or may be associated with, a GDDR SDRAM (e.g., the GDDR SDRAM 155). For example, the memory array 202 may be an example of an array of GDDR SDRAM memory cells. In some cases, to support an increased bandwidth, the memory device 200 may be associated with a synchronized clock signal, such as a read clock signal synchronized with an external clock signal. For example, the memory device 200 may include or may be associated with circuitry configured to generate a read clock signal that is synchronized with the external clock signal. As part of a memory access command to retrieve data stored in the memory array 202, the memory device 200 may obtain a read start signal (e.g., from a C/A decoder of a memory system 110). Based on, in response to, or otherwise associated with obtaining the read start signal, the memory device 200 may retrieve the data.

As indicated above, FIG. 2 is provided as an example. Other examples may differ from what is described with respect to FIG. 2.

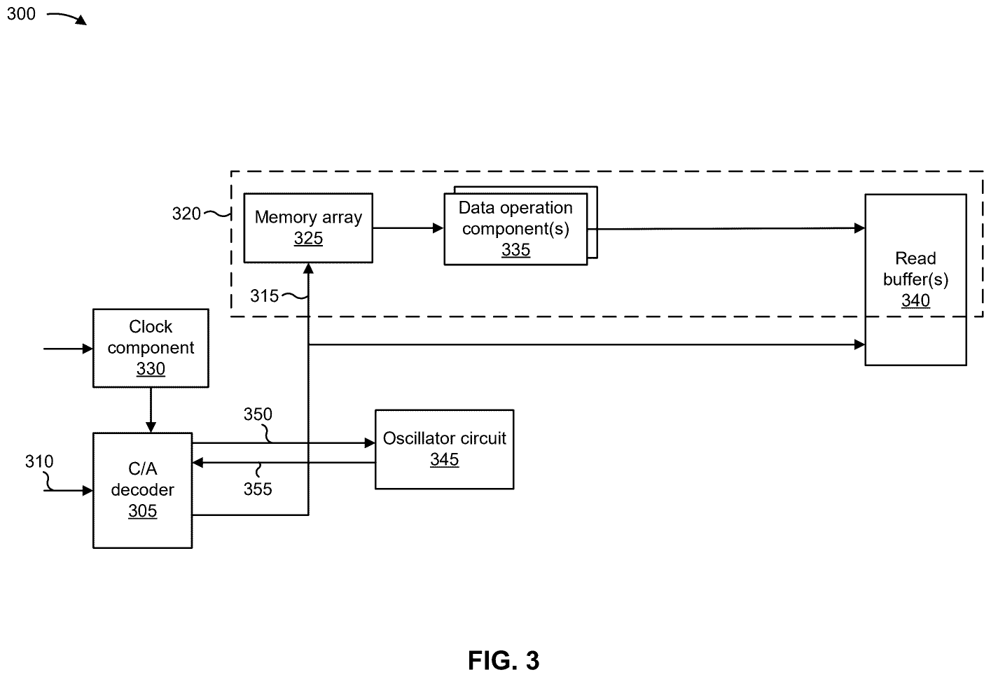

FIG. 3 is a diagram illustrating an example of a system 300 that supports internally modifying access command latency. The system 300 may include aspects of and/or may be implemented by a memory apparatus, such as the memory system 110 and/or a memory device 120. For example, the system 300 may be implemented in the memory system controller 115, in a local controller 125, and/or elsewhere within the memory apparatus. In some implementations, the system 300 may be implemented within one or more GDDR SDRAMs (e.g., the GDDR SDRAM 155). Additionally, or alternatively, the system 300 may be implemented physically close to the GDDR SDRAM(s), such as by being included in the same package (e.g., included in the same system-on-chip (SoC)) as the GDDR SDRAM(s). Additionally, or alternatively, the system 300 may be implemented in a controller associated with the GDDR SDRAM(s), such as a memory system controller 115 and/or a local controller 125.

The system 300 may include one or more components configured to process one or more access commands obtained from a host system (e.g., the host system 105). For example, the system 300 may include a C/A decoder 305 configured to obtain, from a host system (e.g., the host system 105) one or more commands and/or one or more addresses associated with the one or more commands using a C/A bus 310. In some examples, the C/A decoder 305 may include an interface (e.g., a C/A receiver) coupled to the C/A bus 310. The C/A decoder 305 may include logic to process access commands (e.g., read commands) obtained from the host system. For example, the C/A decoder 305 may include logic configured to issue a read start signal 315 to one or more components of a data path 320, such as a memory array 325. The memory array 325 may be a GDDR SDRAM memory array, such as the GDDR SDRAM 155.

The C/A decoder 305 may issue the read start signal 315 after a C/A latency (e.g., after a duration from obtaining a read command). The C/A latency may correspond to a quantity of cycles of a clock signal associated with the host system. For example, the system 300 may include a clock component 330 that may obtain a clock signal from the host system. The C/A decoder 305 may include a counter or other timing circuitry configured to count the quantity of cycles (e.g., periods) of the clock signal over a duration. Additionally, or alternatively, the clock component may generate an internal clock signal using the clock signal obtained from the host system. In such examples, the frequency of the internal clock signal may be a fraction of the frequency of the clock signal obtained from the host system (e.g., may be one fourth the frequency of the clock signal obtained from the host system, may be one half the frequency of the clock signal obtained from the host system). Further, in such examples, the C/A decoder 305 may include a counter or other timing circuitry configured to count the quantity of cycles (e.g., periods) of the internal clock signal over a duration. After the C/A latency has expired (e.g., after the timing circuitry has identified that the quantity of clock cycles of the clock signal obtained from the host system and/or the quantity of clock cycles of the internal clock signal is greater than or equal to the C/A latency), the C/A decoder 305 may issue the read start signal 315.

Based on, in response to, or otherwise associated with obtaining the read start signal 315, the memory array 325 may retrieve data associated with the read command. In some examples, the memory array 325 may provide the data to one or more data operation components 335 of the data path 320. The one or more data operation components 335 may include circuitry configured to apply one or more error control operations to the data. The one or more error control operations may include parity operations to detect and, in some cases, correct one or more errors in the data using parity information associated with the data, such as error correction code (ECC) operations, cyclic redundancy check (CRC) operations, encoding operations, and/or decoding operations, among other examples. After performing the one or more error control operations, the one or more data operation components 335 may store the data to one or more read buffers 340 of the data path 320.

As described herein, “data path delay” may refer to the duration between the data path 320 obtaining the read start signal 315 and the data being stored to the one or more read buffers 340. As the data is propagated through the data path 320, each component of the data path 320 may add a respective portion to the data path delay. Moreover, the portion of delay added by each component may change depending on operation conditions and/or process conditions of the memory apparatus. For example, as the temperature and/or the operating voltage of the memory apparatus change (e.g., due to noise or other fluctuations in the supply voltage), the rate at which transistors or other components of the data path 320 activate and/or deactivate (e.g., the switching speed) may change. Further, different process conditions, such as variations in transistor properties, channel length, doping concentration, and/or impurities, among other examples, may result in variations in switching times. Accordingly, the data path delay may change (e.g., increase or decrease) as the operating conditions and/or the process conditions of the memory apparatus change. For example, a first set of conditions (e.g., a first temperature, a first voltage supply, and/or a first set of transistor switching times) may result in a first data path delay, and a second set of operating (e.g., a second temperature, a second voltage supply, and/or a second set of transistor switching times) may result in a second data path delay that is greater than first data path delay.

The memory apparatus may include an oscillator circuit 345 configured to provide information associated with the operating conditions and/or the process conditions of the memory apparatus. The oscillator circuit 345 may include one or more components configured to periodically oscillate (e.g., toggle, switch) between one or more possible states. For example, the oscillator circuit 345 may be a ring oscillator. As described herein, “ring oscillator” refers to a series of logical circuits, such as a sequence of inverters having an odd quantity of inverters. An inverter of the sequence of inverters may have an input coupled with the output of the previous inverter of the sequence, and the inverter may have an output coupled with an input of the subsequent inverter of the sequence. Further, an input of the first inverter of the sequence may be coupled with an output of the last inverter of the sequence, such that the sequence of oscillators forms a closed loop (e.g., a “ring”).

Because the sequence has an odd quantity of inverters, if a signal having a first logic state (e.g., a high voltage) is input to the sequence of inverters (e.g., if a high voltage is applied to the input of the first inverter of the sequence), then the signal may propagate through the sequence (e.g., being inverted by each inverter of the sequence), and the last inverter of the sequence may output a signal having a second logic state that is inverted with respect to the first logic state (e.g., a low voltage). Each inverter of the sequence of inverters may contribute a respective amount of delay (e.g., a respective amount of time between obtaining a signal, inverting the signal, and outputting the inverted signal). Accordingly, the duration between the first inverter obtaining an input signal and the last inverter outputting the inversion of the input signal, which may be referred to as the delay of the oscillator circuit 345, may correspond to the sum of the delays contributed by each inverter of the sequence. Further, because the sequence of inverters forms a closed loop, the output of the last inverter may propagate to the input of the first inverter, such that the output of the sequence of inverters oscillates between the first logic state and the second logic state. Thus, the oscillator circuit 345 may have a period that is twice the delay of the oscillator circuit 345.

In some examples, the delay of an inverter may depend on timing properties (e.g., switching speeds) of transistors of the inverter. Accordingly, the delay of the oscillator circuit 345 may change depending on variations in operating conditions of the memory apparatus (e.g., variations in temperature, variations in voltage, and/or process variations). Thus, changes in the period of the oscillator circuit 345 due to operating condition variations may be commensurate with changes to the delay of the data path 320 due to operating condition variations. Said another way, an increase in the period (e.g., a lower frequency) of the oscillator circuit 345 may correspond to an increase in the delay of the data path 320. Similarly, a decrease in the period (e.g., a higher frequency) of the oscillator circuit 345 may correspond to a decrease in the delay of the data path 320.

To account for changes in the delay of the data path 320 due to operating condition variations, the memory apparatus may extract information associated with the operating condition variations from the oscillator circuit 345. For example, the C/A decoder 305 may initiate the oscillator circuit 345 (e.g., by providing a count start signal 350 to the oscillator circuit 345). Based on, in response to, or otherwise associated with initiating the oscillator circuit 345, the oscillator circuit 345 may begin oscillating. In some examples, the oscillator circuit 345 may include a counter configured to count the quantity of oscillations of the oscillator circuit 345. After a duration, the oscillator circuit 345 may provide, and the C/A decoder 305 may obtain, a count value 355 indicating the quantity of oscillations of the oscillator circuit 345. In some examples, the C/A decoder 305 and/or the oscillator circuit 345 may use the count value 355 to determine a measured metric of the oscillator circuit 345, such as a measured period and/or a measured frequency of the oscillator circuit 345.

The C/A decoder 305 may selectively modify the C/A latency by a first value or a second value based on the measured metric. As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination. As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

For example, the C/A decoder 305 may compare the measured metric to a threshold. The threshold may include a reference metric (e.g., a reference period, a reference frequency) associated with the oscillator circuit 345. The reference metric may correspond to a period and/or a frequency of the oscillator circuit 345, under a given set of operating conditions. Accordingly, if the measured metric satisfies the threshold (e.g., if the measured period is greater than the reference period and/or if the measured frequency is less than the reference frequency), then the memory apparatus may determine that the data path delay is greater than the data path delay associated with the given set of operating conditions. Thus, the C/A decoder 305 may reduce the C/A latency by the first value. Alternatively, if the measured metric does not satisfy the threshold (e.g., if the measured period is less than the reference period and/or if the measured frequency is greater than the reference frequency), then the memory apparatus may determine that the data path delay is less than the data path delay associated with the given set of operating conditions. Thus, the C/A decoder 305 may increase the C/A latency by the second value.

In some examples, the C/A decoder 305 may determine the threshold based on the frequency of the clock signal associated with the host system (e.g., the clock signal obtained by the clock component 330). For example, the memory apparatus may store a frequency value indicating the frequency of the clock signal. The C/A decoder 305 may obtain the frequency value from the mode register, and may select a threshold commensurate with the frequency value, such as by using a mapping or other association between frequency values and thresholds. For example, a higher frequency value may correspond to a higher threshold (e.g., a larger reference period, a lower reference frequency), and a lower value may correspond to a lower threshold (e.g., a smaller reference period, a higher reference frequency). In such examples, the memory apparatus may update the frequency value. For example, the host system may provide, and the memory apparatus may obtain, a command indicating an updated frequency value. Based on, in response to, or otherwise associated with obtaining the command, the memory apparatus may store the updated frequency value to the mode register.

Additionally, or alternatively, the C/A decoder 305 may modify the C/A latency by an amount commensurate with the measured metric. For example, the C/A decoder 305 may use a mapping, such as a look-up table. The mapping may include one or more entries that indicate associations between metrics (e.g., periods and/or frequencies) and associated C/A latencies. For example, an entry may include a metric, and/or a range of metrics, and an associated C/A latency. The C/A decoder 305 may use the mapping to identify a C/A latency associated with the measured metric, such as by identifying an entry having a metric nearest the measured metric and/or by identifying an entry having a range of metrics that includes the measured metric. The C/A decoder 305 may modify the C/A latency to the identified C/A latency. By modifying the C/A latency based on the measured metric, the system 300 may reduce underflow and/or overflow conditions in the one or more read buffers 340. For example, by modifying the C/A latency based on the measured metric of the oscillator circuit 345, the system 300 may reduce variations in duration between the decoder 305 obtaining a read command and the data path 320 storing data associated with the read command to one or more read buffers 340. Accordingly, the system 300 may mitigate underflow of the one or more read buffers 340, which may improve system performance, such as by reducing latency of the system 300. Additionally, the system 300 may mitigate overflow of the one or more read buffers 340, which may allow for a more efficient size of the system 300, decreased manufacturing costs, and/or decreased system complexity, among other benefits.

In some examples, the C/A decoder 305 may store the modified C/A latency, such as to a mode register of the C/A decoder 305. In such examples, after obtaining a read command, the C/A decoder 305 may wait (e.g., delay) for a duration corresponding to the C/A latency (e.g., may delay for a quantity of clock cycles indicated by the C/A latency). After the duration, the C/A decoder 305 may provide (e.g., issue), and the memory array 325 may obtain, the read start signal 315. Additionally, or alternatively, the C/A decoder 305 may store the measured metric to a mode register. In such examples, after obtaining a read command, the C/A decoder 305 may determine the C/A latency using the measured metric, as described in greater detail elsewhere herein.

In some examples, the memory apparatus may update the C/A latency and/or the measured metric as part of memory management operations of the memory apparatus, such as during an idle mode of the memory apparatus, during a sleep mode of the memory apparatus, during a power-on operation of the memory apparatus, and/or in response to updating the frequency of the clock signal provided by the host system. Additionally, or alternatively, the host system may instruct the memory apparatus to update the C/A latency and/or the measured metric. For example, the host system may provide, and the memory apparatus may obtain, a command to update the C/A latency and/or a command to update the measured metric. Based on, in response to, or otherwise associated with obtaining the command, the C/A decoder 305 may issue the count start signal 350 to obtain an updated measured metric, and may determine an updated C/A latency using the updated measured metric.

As indicated above, FIG. 3 is provided as an example. Other examples may differ from what is described with regard to FIG. 3.

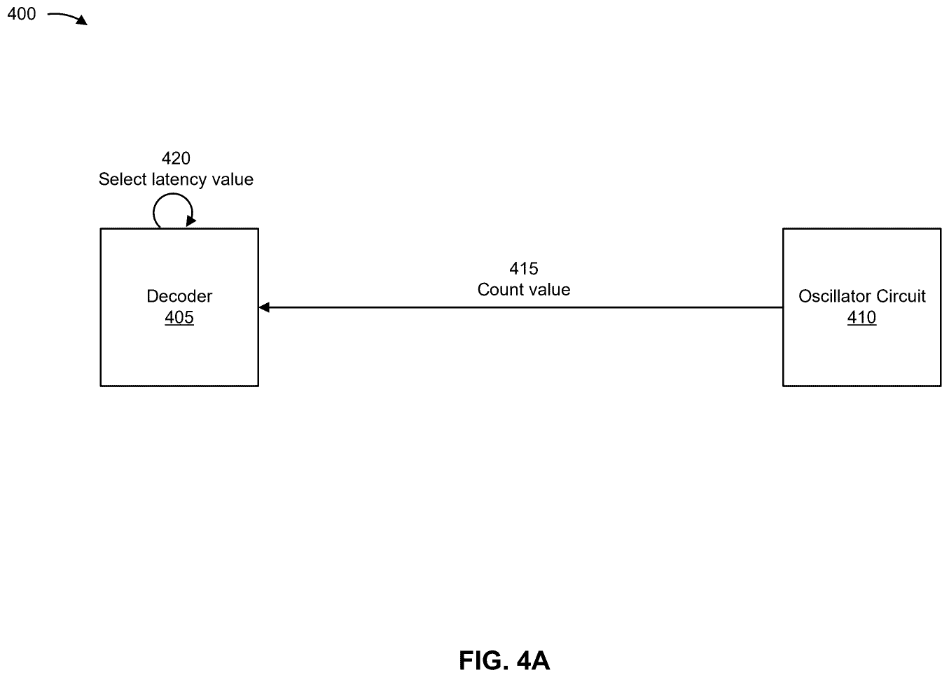

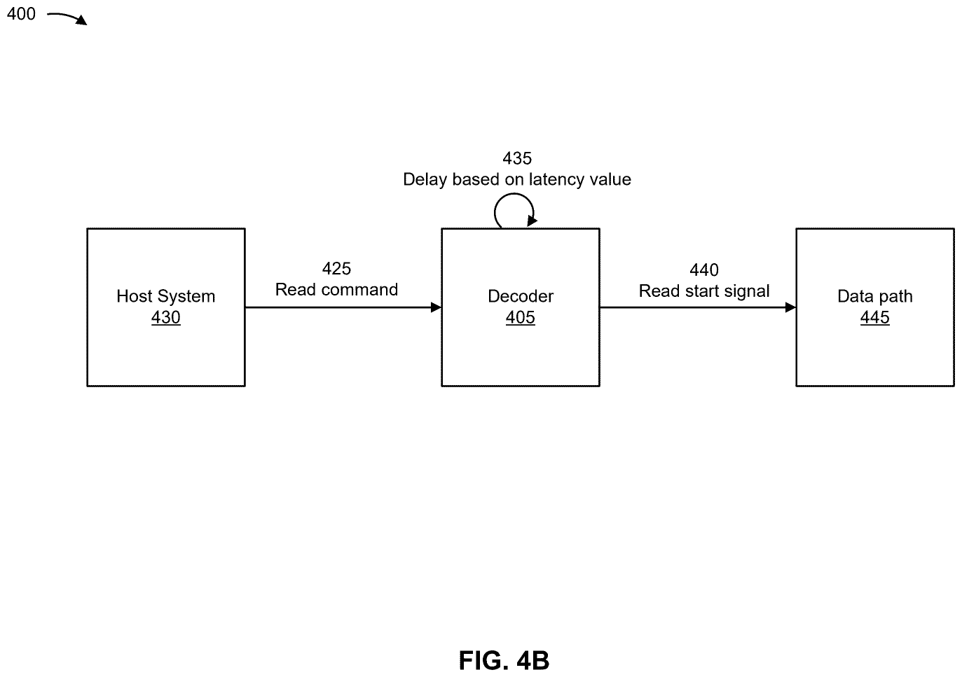

FIGS. 4A and 4B are diagrams of an example 400 that supports internally modifying access command latency. The operations described in connection with FIGS. 4A and 4B may be performed by a memory apparatus, such as the memory system 110 and/or the system 300. The operations described in connection with FIGS. 4A and 4B may further be performed by one or more components of a memory apparatus, such as the memory system controller 115, one or more memory devices 120, one or more local controllers 125, the GDDR SDRAM 155, the memory device 200, the C/A decoder 305, the memory array 325, the one or more data operation components 335, the one or more read buffers 340, and/or the oscillator circuit 345. Additionally, operations described in connection with FIGS. 4A and 4B may be performed by the host system 105 and/or one or more components of the host system 105, such as the host processor 150 and/or the host interface 140.

The example 400 may enable a decoder 405 of the memory apparatus to modify the C/A latency using an oscillator circuit 410. The decoder 405 may be an example of the C/A decoder 305. The oscillator circuit 410 may be an example of the oscillator circuit 345. As shown in FIG. 4A, and by reference number 415, the oscillator circuit 410 may provide, and the decoder 405 may obtain, a count value. The count value may be a quantity of oscillations of the oscillator circuit 410 within a duration. For example, the decoder 405 may issue, and the oscillator circuit 410 may obtain, a count start signal. Based on, in response to, or otherwise associated with obtaining the count start signal, the oscillator circuit 410 may initiate an oscillator (e.g., a ring oscillator). The oscillator circuit 410 may include a counter, which may count the quantity of oscillations of the oscillator (e.g., may determine the count value) over the duration.

As shown by reference number 420, the decoder 405 may select a value by which to modify a latency associated with memory access commands (e.g., the C/A latency). For example, the decoder 405 may determine whether a delay associated with a data path of the memory apparatus satisfies a threshold. To determine whether the delay satisfies the threshold, the decoder 405 may compare the measured metric to a reference metric, such as a reference period and/or a reference frequency, of the oscillator circuit 410. If the measured period is greater than the reference period, and/or if the measured frequency is less than the reference frequency, then the decoder 405 may reduce the latency by a first value. Alternatively, if the measured period is less than the reference period, and/or if the measured frequency is greater than the reference frequency, then the decoder 405 may increase the latency by a second value.

Additionally, or alternatively, the decoder 405 may modify the latency by an amount commensurate with the measured metric. For example, the decoder 405 may use a mapping, such as a look-up table. The mapping may include one or more entries that indicate associations between possible metrics and associated latencies. For example, an entry may include a metric, and/or a range of metrics, and an associated latency. The decoder 405 may use the mapping to identify a latency associated with the measured metric, such as by identifying an entry having a metric nearest the measured metric and/or by identifying an entry having a range of metrics that includes the measured metric. The decoder 405 may modify the latency to be the identified latency.

As shown in FIG. 4B, and by reference number 425, a host system 430 may provide, and the decoder 405 may obtain, a read command for data stored to the memory apparatus (e.g., stored to a memory device 120 and/or stored to a GDDR SDRAM 155). As shown by reference number 435, the decoder 405 may delay for a duration corresponding to the modified latency. In some examples, the modified latency may indicate a quantity of cycles of a clock signal provided by the host system 430. In such examples, the decoder 405 may include a counter or other timing circuitry configured to count the quantity of cycles of the clock signal. As shown by reference number 440, after the latency has expired (e.g., after the timing circuitry has identified that the quantity of clock cycles is greater than or equal to the latency), the decoder 405 may issue, and a data path 445 may obtain, a read start signal.

As shown by reference number 440, based on, in response to, or otherwise associated with obtaining the read start signal, the data path 445 may retrieve data associated with the read command. In some examples, the data path 445 may apply one or more error control operations to the data. After performing the one or more error control operations, the data path 445 may store the data to one or more read buffers of the data path 445.

As indicated above, FIGS. 4A and 4B are provided as examples. Other examples may differ from what is described with regard to FIGS. 4A and 4B.

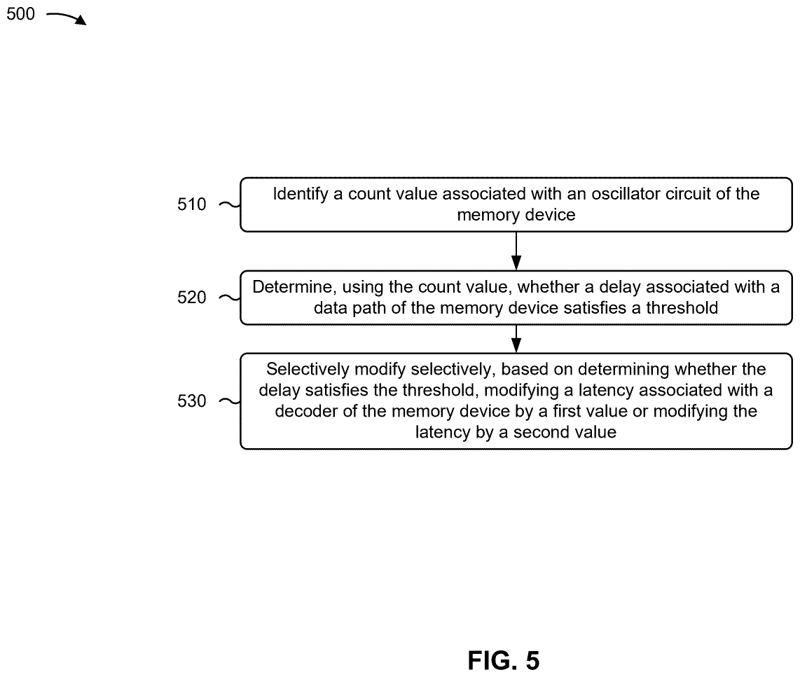

FIG. 5 is a flowchart of an example method 500 associated with internally modifying access command latency. In some implementations, a memory system (e.g., the memory system 110) may perform or may be configured to perform the method 500. In some implementations, another device or a group of devices separate from or including the memory system (e.g., the host system 105) may perform or may be configured to perform the method 500. Additionally, or alternatively, one or more components of the memory system (e.g., the memory system controller, 115, the GDDR SDRAM 155, the volatile memory arrays(s) 135, one or more memory devices 120, a memory device 200, a decoder 305, a data path 320, and/or an oscillator circuit 345) may perform or may be configured to perform the method 500. Thus, means for performing the method 500 may include the memory device and/or one or more components of the memory system. Additionally, or alternatively, a non-transitory computer-readable medium may store one or more instructions that, when executed by the memory system (e.g., the controller 115 of the memory system 110), cause the memory system to perform the method 500.

As shown in FIG. 5, the method 500 may include identifying a count value associated with an oscillator circuit of the memory device (block 510). As further shown in FIG. 5, the method 500 may include determining, using the count value, whether a delay associated with a data path of the memory device satisfies a threshold (block 520). As further shown in FIG. 5, the method 500 may include selectively, based on determining whether the delay satisfies the threshold, modifying a latency associated with a decoder of the memory device by a first value or modifying the latency by a second value (block 530).

The method 500 may include additional aspects, such as any single aspect or any combination of aspects described below and/or described in connection with one or more other methods or operations described elsewhere herein.

In a first aspect, the method 500 includes obtaining, from a host system, a read command, issuing, by the decoder and after a duration corresponding to the latency, a read start signal, and storing, based on issuing the read start signal, data associated with the read command to a read buffer.

In a second aspect, alone or in combination with the first aspect, the method 500 includes identifying a frequency parameter using a mode register of the memory device, the frequency parameter associated with a clock signal of a host system, and identifying the threshold based on the frequency parameter and the count value, wherein determining whether the delay satisfies the threshold is based on identifying the threshold.

In a third aspect, alone or in combination with one or more of the first and second aspects, the method 500 includes obtaining, from a host system, a command indicating a frequency parameter, the frequency parameter associated with a clock signal of the host system, and storing, based on obtaining the command, the frequency parameter to a mode register of the memory device.

In a fourth aspect, alone or in combination with one or more of the first through third aspects, the method 500 includes updating the count value based on at least one of an idle mode of the memory device, a sleep mode of the memory device, a power-on operation of the memory apparatus, or a change in a frequency of a clock signal associated with a host system.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

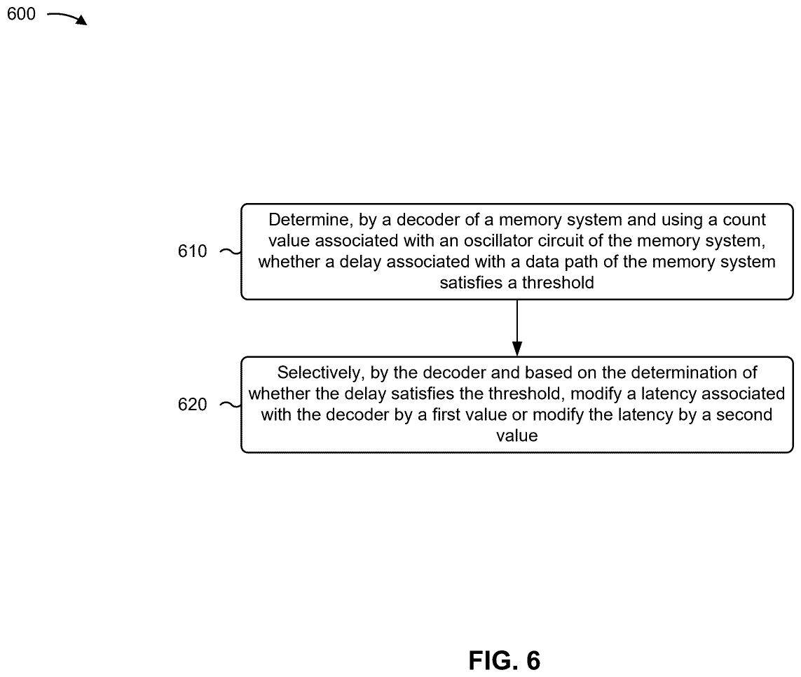

FIG. 6 is a flowchart of an example method 600 associated with internally modifying access command latency. In some implementations, a memory system (e.g., the memory system 110) may perform or may be configured to perform the method 600. In some implementations, another device or a group of devices separate from or including the memory system (e.g., the host system 105) may perform or may be configured to perform the method 600. Additionally, or alternatively, one or more components of the memory system (e.g., the memory system controller, 115, the GDDR SDRAM 155, the volatile memory arrays(s) 135, one or more memory devices 120, a memory device 200, a decoder 305, a data path 320, and/or an oscillator circuit 345) may perform or may be configured to perform the method 600. Thus, means for performing the method 600 may include the memory device and/or one or more components of the memory system. Additionally, or alternatively, a non-transitory computer-readable medium may store one or more instructions that, when executed by the memory system (e.g., the controller 115 of the memory system 110), cause the memory system to perform the method 600.

As shown in FIG. 6, the method 600 may include determining, by a decoder of a memory system and using a count value associated with an oscillator circuit of the memory system, whether a delay associated with a data path of the memory system satisfies a threshold (block 610). As further shown in FIG. 6, the method 600 may include selectively, by the decoder and based on the determination of whether the delay satisfies the threshold, modifying a latency associated with the decoder by a first value or modifying the latency by a second value (block 620).

The method 600 may include additional aspects, such as any single aspect or any combination of aspects described below and/or described in connection with one or more other methods or operations described elsewhere herein.

In a first aspect, the method 600 includes modifying, based on the delay satisfying the threshold, the latency by the first value.

In a second aspect, alone or in combination with the first aspect, the method 600 includes modifying, based on the delay not satisfying the threshold, the latency by the second value.

In a third aspect, alone or in combination with one or more of the first and second aspects, the method 600 includes obtaining, from a host system, a read command, and issuing, after a duration corresponding to the latency, a read start signal to the data path.

In a fourth aspect, alone or in combination with one or more of the first through third aspects, the method 600 includes obtaining the read start signal from the decoder, and storing, based on obtaining the read start signal, data associated with the read command to a read buffer.

In a fifth aspect, alone or in combination with one or more of the first through fourth aspects, the method 600 includes obtaining a frequency parameter from a mode register, the frequency parameter associated with a clock signal of a host system, and identifying the threshold based on the frequency parameter and the count value.

In a sixth aspect, alone or in combination with one or more of the first through fifth aspects, the oscillator circuit comprises a ring oscillator, and the count value is based on a quantity of oscillations of the ring oscillator.

In a seventh aspect, alone or in combination with one or more of the first through sixth aspects, the latency corresponds to a quantity of cycles of a clock signal associated with a host system.

In an eighth aspect, alone or in combination with one or more of the first through seventh aspects, a frequency of the oscillator circuit is based on at least one of a temperature of the oscillator circuit, a process condition of the oscillator circuit, or a voltage of the oscillator circuit, and the count value is based on the frequency of the oscillator circuit.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

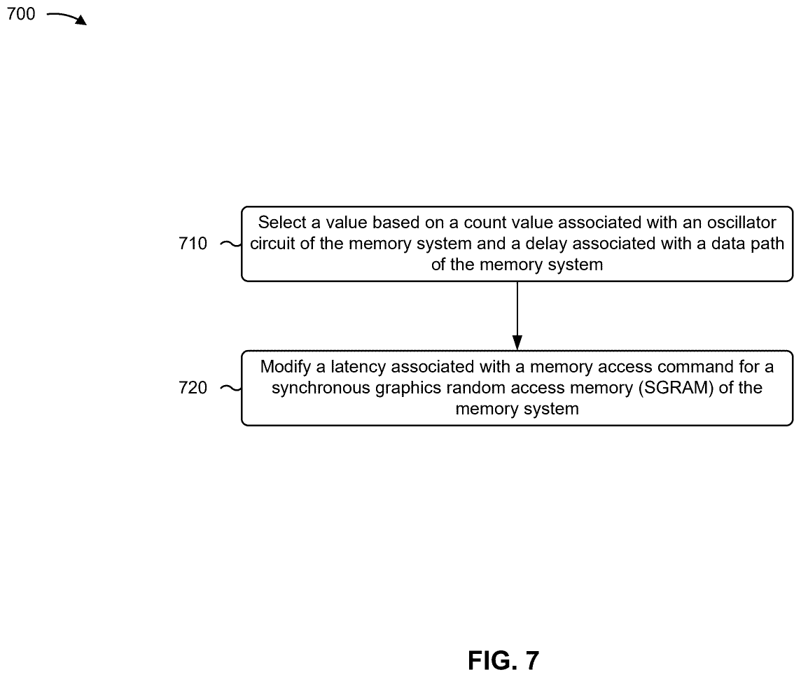

FIG. 7 is a flowchart of an example method 700 associated with internally modifying access command latency. In some implementations, a memory system (e.g., the memory system 110) may perform or may be configured to perform the method 700. In some implementations, another device or a group of devices separate from or including the memory system (e.g., the host system 105) may perform or may be configured to perform the method 700. Additionally, or alternatively, one or more components of the memory system (e.g., the memory system controller, 115, the GDDR SDRAM 155, the volatile memory arrays(s) 135, one or more memory devices 120, a memory device 200, a decoder 305, a data path 320, and/or an oscillator circuit 345) may perform or may be configured to perform the method 700. Thus, means for performing the method 700 may include the memory device and/or one or more components of the memory system. Additionally, or alternatively, a non-transitory computer-readable medium may store one or more instructions that, when executed by the memory system (e.g., the controller 115 of the memory system 110), cause the memory system to perform the method 700.

As shown in FIG. 7, the method 700 may include selecting a value based on a count value associated with an oscillator circuit of the memory system and a delay associated with a data path of the memory system (block 710). As further shown in FIG. 7, the method 700 may include modifying a latency associated with a memory access command for a GDDR SDRAM of the memory system (block 720).

The method 700 may include additional aspects, such as any single aspect or any combination of aspects described below and/or described in connection with one or more other methods or operations described elsewhere herein.

In a first aspect, the method 700 includes obtaining, from a host system, an access command for data stored by the GDDR SDRAM, and issuing, after a duration corresponding to the latency, a read start signal to the data path.

In a second aspect, alone or in combination with the first aspect, the method 700 includes obtaining, at the data path, the read start signal from the decoder, and storing, based on obtaining the read start signal, the data to a read buffer.

In a third aspect, alone or in combination with one or more of the first and second aspects, the oscillator circuit comprises a ring oscillator, and the count value corresponds to a quantity of oscillations of the ring oscillator.

In a fourth aspect, alone or in combination with one or more of the first through third aspects, the latency corresponds to a quantity of cycles of a clock signal associated with a host system.

In a fifth aspect, alone or in combination with one or more of the first through fourth aspects, a frequency of the oscillator circuit is based on at least one of a temperature of the oscillator circuit, a process condition of the oscillator circuit, or a voltage of the oscillator circuit, and the count value is based on the frequency of the oscillator circuit.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a system includes: an oscillator circuit configured to provide a count value; a data path; and a decoder configured to: determine, using the count value, whether a delay associated with the data path satisfies a threshold; and selectively, based on the determination of whether the delay satisfies the threshold, modify a latency associated with the decoder by a first value or modify the latency by a second value.

In some implementations, a system includes: a GDDR SDRAM; an oscillator circuit configured to provide a count value; a data path of the GDDR SDRAM; and a decoder configured to: select, based on the count value and a delay associated with the data path, a value; and modify, by the value, a latency associated with a memory access command for the GDDR SDRAM.

In some implementations, a method includes: identifying, by a memory device, a count value associated with an oscillator circuit of the memory device; determining, by the memory device and using the count value, whether a delay associated with a data path of the memory device satisfies a threshold; and selectively, based on determining whether the delay satisfies the threshold, modifying a latency associated with a decoder of the memory device by a first value or modifying the latency by a second value.

In some implementations, a method includes: determining, by a decoder of a memory system and using a count value associated with an oscillator circuit of the memory system, whether a delay associated with a data path of the memory system satisfies a threshold; and selectively, by the decoder and based on the determination of whether the delay satisfies the threshold, modifying a latency associated with the decoder by a first value or modifying the latency by a second value.

In some implementations, a method includes: selecting, by a decoder of a memory system, a value based on a count value associated with an oscillator circuit of the memory system and a delay associated with a data path of the memory system; and modifying, by the decoder, a latency associated with a memory access command for a GDDR SDRAM of the memory system.

In some implementations, an apparatus includes: means for identifying a count value associated with an oscillator circuit of the memory device; means for determining, using the count value, whether a delay associated with a data path of the memory device satisfies a threshold; and means for selectively modifying selectively, based on determining whether the delay satisfies the threshold, modifying a latency associated with a decoder of the memory device by a first value or modifying the latency by a second value.

In some implementations, an apparatus includes: means for determining, using a count value associated with an oscillator circuit of a memory system, whether a delay associated with a data path of the memory system satisfies a threshold; and means for selectively, based on the determination of whether the delay satisfies the threshold, modifying a latency associated with the decoder by a first value or modifying the latency by a second value.

In some implementations, an apparatus includes: means for selecting a value based on a count value associated with an oscillator circuit of the memory system and a delay associated with a data path of the memory system; and means for modifying a latency associated with a memory access command for a GDDR SDRAM of the memory system.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
an oscillator circuit configured to provide a count value;
a data path; and
a decoder configured to:
determine, using the count value, whether a delay associated with the data path satisfies a threshold; and
selectively, based on the determination of whether the delay satisfies the threshold, modify a latency associated with the decoder by a first value or modify the latency by a second value.

2. The system of claim 1, wherein, to selectively modify the latency by the first value or the second value, the decoder is further configured to:
modify, based on the delay satisfying the threshold, the latency by the first value.

3. The system of claim 1, wherein, to selectively modify the latency by the first value or the second value, the decoder is further configured to:
modify, based on the delay not satisfying the threshold, the latency by the second value.

4. The system of claim 1, wherein the decoder is further configured to:
obtain, from a host system, a read command; and
issue, after a duration corresponding to the latency, a read start signal to the data path.

5. The system of claim 4, wherein the data path is configured to:
obtain the read start signal from the decoder; and
store, based on obtaining the read start signal, data associated with the read command to a read buffer.

6. The system of claim 1, wherein the decoder is further configured to:
obtain a frequency parameter from a mode register, the frequency parameter associated with a clock signal of a host system; and
identify the threshold based on the frequency parameter and the count value.

7. The system of claim 1, wherein the oscillator circuit comprises a ring oscillator, and wherein the count value is based on a quantity of oscillations of the ring oscillator.

8. The system of claim 1, wherein the latency corresponds to a quantity of cycles of a clock signal associated with a host system.

9. The system of claim 1, wherein a frequency of the oscillator circuit is based on at least one of a temperature of the oscillator circuit, a process condition of the oscillator circuit, or a voltage of the oscillator circuit, and wherein the count value is based on the frequency of the oscillator circuit.

10. A system, comprising:
a memory array;
an oscillator circuit configured to provide a count value;
a data path of the memory array; and
a decoder configured to:
select, based on the count value and a delay associated with the data path, a value; and
modify, by the value, a latency associated with a memory access command for the memory array.

11. The system of claim 10, wherein the decoder is further configured to:
obtain, from a host system, an access command for data stored by the memory array; and
issue, after a duration corresponding to the latency, a read start signal to the data path.

12. The system of claim 11, wherein the data path is configured to:
obtain the read start signal from the decoder; and
store, based on obtaining the read start signal, the data to a read buffer.

13. The system of claim 10, wherein the oscillator circuit comprises a ring oscillator, and wherein the count value corresponds to a quantity of oscillations of the ring oscillator.

14. The system of claim 10, wherein the latency corresponds to a quantity of cycles of a clock signal associated with a host system.

15. The system of claim 10, wherein a frequency of the oscillator circuit is based on at least one of a temperature of the oscillator circuit, a process condition of the oscillator circuit, or a voltage of the oscillator circuit, and wherein the count value is based on the frequency of the oscillator circuit.

16. A method, comprising:
identifying, by a memory device, a count value associated with an oscillator circuit of the memory device;
determining, by the memory device and using the count value, whether a delay associated with a data path of the memory device satisfies a threshold; and
selectively, based on determining whether the delay satisfies the threshold, modifying a latency associated with a decoder of the memory device by a first value or modifying the latency by a second value.

17. The method of claim 16, further comprising:
obtaining, from a host system, a read command;
issuing, by the decoder and after a duration corresponding to the latency, a read start signal; and
storing, based on issuing the read start signal, data associated with the read command to a read buffer.

18. The method of claim 16, further comprising:
identifying a frequency parameter using a mode register of the memory device, the frequency parameter associated with a clock signal of a host system; and
identifying the threshold based on the frequency parameter and the count value, wherein determining whether the delay satisfies the threshold is based on identifying the threshold.

19. The method of claim 16, further comprising:
obtaining, from a host system, a command indicating a frequency parameter, the frequency parameter associated with a clock signal of the host system; and
storing, based on obtaining the command, the frequency parameter to a mode register of the memory device.

20. The method of claim 16, further comprising:
updating the count value based on at least one of an idle mode of the memory device, a sleep mode of the memory device, a power-on operation of the memory apparatus, or a change in a frequency of a clock signal associated with a host system.
